(19) United States
(12) Patent Application Publication
(10) Pub. No.: US 2024/0309894 A1
(43) Pub. Date: Sep. 19, 2024

(54) Self-Sensing Pressure-Driven Extending Actuator

(71) Applicant: LUDLUM MEASUREMENTS, INC., Sweetwater, TX (US)

(72) Inventors: Wyatt Marshall Felt, Salt Lake City, UT (US); Jacob Ryan Greenwood, Orem, UT (US)

(21) Appl. No.: 18/601,864

(22) Filed: Mar. 11, 2024

Related U.S. Application Data
(60) Provisional application No. 63/489,962, filed on Mar. 13, 2023.

(51) Int. Cl. F15B 15/08; B23K 20/10; B23K 101/00; F15B 13/16

(52) U.S. Cl. CPC F15B 15/08; B23K 20/10; F15B 13/16; B23K 2101/003; F15B 2211/526; F15B 2211/605; F15B 2211/6303

(57) ABSTRACT

Systems, devices, and methods for a self-sensing fluid-driven extending actuation device and associated methods where a fluid controller adds fluid into or removes fluid from a coiled device made from sealed flat layers of material; the pressurized fluid expands the internal volume of the layers causing the device to partially un-coil and extend; a resistance measurement circuit measures the length of the extended section and uses it to control the fluid added or removed from the device to achieve a desired length.

### CROSS-REFERENCE TO RELATED APPLICATIONS

This application is claims the priority benefit of U.S. Provisional Application No. 63/489,962, titled “Self-Sensing Pressure-Driven Extending Actuator” filed on Mar. 13, 2023, the entirety of which is incorporated herein by reference.

### GOVERNMENT LICENSE RIGHTS

This invention was made with government support under DE-SC0022837 awarded by the U.S. Department of Energy. The government has certain rights in the invention.

### TECHNICAL FIELD

Embodiments relate generally to actuators whose motion is created by pressurized fluid and more particularly to actuators that have a coiled or spiral of flat material when not pressurized.

### BACKGROUND

The development and application of a wide-variety of soft fluid-driven actuation techniques has led to extensive innovation in mechanisms and robotics. Typically made from elastomers, fabrics, or thin plastics, these soft actuators are driven by the expansion of an internally contained volume of air. The actuators tend to behave in a “soft”' or compliant way because the materials are often flexible and the fluid may be compressible (e.g., air). Examples of common soft fluid-driven actuators include axially contracting fiber-reinforced actuators, bellows-like axially extending actuators, and bellows-like bending actuators (which reinforce one side of the actuator to convert the extension into bending).

### SUMMARY

In some aspects, the techniques described herein relate to a device (100) including a: a coiled section (102) configured to be expanded into an expanded section (101) via addition of a pressurized fluid (208) through a fluid inlet (103), wherein the coiled section (102) includes a sealed end (104), and wherein the expanded section (101) and the coiled section (102) include sealed edges (207) to contain the pressurized fluid (208); and one or more conductive layers (204) configured to form an internal electrical junction (206) at a point of transition between the coiled section (102) and expanded section (101), wherein a length of the expanded section (101) is configured to be determined by measuring a resistance of a circuit formed by the one or more conductive layers (204).

In some aspects, the techniques described herein relate to a method including: measuring, by electrical wires (404), a resistance of a circuit formed by conductive layers (204); and controlling, by a fluid controller (401), a fluid added via a fluid inlet (103) to achieve a desired length of an expanded section (101) based on the measurement of the resistance of the circuit.

In some aspects, the techniques described herein relate to a method of fabrication of a self-sensing fluid-driven actuator: shifting a first backing layer relative to a second backing layer in a longitudinal direction, wherein the first backing layer is coupled to a first conductive layer and the second backing layer is coupled to a second conductive layer; and bonding the first backing layer to the second backing layer at a sealed edge in a coiled configuration.

### BRIEF DESCRIPTION OF THE DRAWINGS

The components in the figures are not necessarily to scale, emphasis instead being placed upon illustrating the principles of the invention. Like reference numerals designate corresponding parts throughout the different views. Embodiments are illustrated by way of example and not limitation in the figures of the accompanying drawings, in which:

FIGS. 1A-1C depict side-views of a self-sensing actuator with the sequence illustrating the progressive un-coiling of the actuator under fluid pressure, according to one embodiment;

FIGS. 2A and 2B depict cross-sections of the self-sensing actuator edge illustrating the layers that may make up an embodiment of the actuator, with the thicknesses of those elements exaggerated for clarity, according to one embodiment;

FIG. 3 depicts a photograph of an embodiment of the self-sensing actuator, according to one embodiment;

FIG. 4 depicts the self-sensing actuator in combination with a controllable pressurized fluid source and a resistance-measurement circuit, according to one embodiment;

FIG. 5 shows a high-level block diagram and process of a computing system for implementing an embodiment of the system and process;

FIG. 6 shows a block diagram and process of an exemplary system in which an embodiment may be implemented; and

FIG. 7 depicts a cloud computing environment for implementing an embodiment of the system and process disclosed herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The disclosed self-sensing actuator uses layers of flat material arranged in a coil to create an expandable volume that un-coils as the actuator extends. By making the innermost layers of the fluid-volume conductive, the point at which the coil begins can be measured via a resistance of a circuit formed by the conductive paths.

The coiled spiral fluid-driven mechanism in the disclosed system and method may mechanically unroll in a similar manner as a breath-actuated “party horn.” Though the name in English is somewhat ambiguous, other languages have more unique monikers (German: “rollpfeife,” “luftrüssel”; Spanish: “espantasuegras”; Italian: “lingua di Menelik”; Japanese: “fukimodoshi”), some of which date back more than a century to the popularity of the horn in carnival celebrations.

While other types of fluid-driven actuators have shown great versatility in their applications, the distance over which these actuators can traverse is fundamentally limited to some fraction or multiple of their initial length. Contracting fiber-reinforced actuators and “peano” actuators, for example, can typically only reduce their length by less than 50%. Bellows-like actuators, on the other hand, can extend in an accordion-like manner to several multiples of their contracted length when pressurized. Correspondingly, when subjected to vacuum pressure, bellows-like structures can act as contractile actuators with dramatic contraction ratios. The ratio of the extended length to the contracted length is limited, however, by the thickness of the many folds.

In many ways, soft pneumatic actuation distance is limited by the ability to efficiently store the material needed to enclose the fluid volume as it expands. The present system and method allow for long extensions by storing the enclosing volume in a roll. The disclosed system and method may also include a mechanism for sensing the length of the actuator.

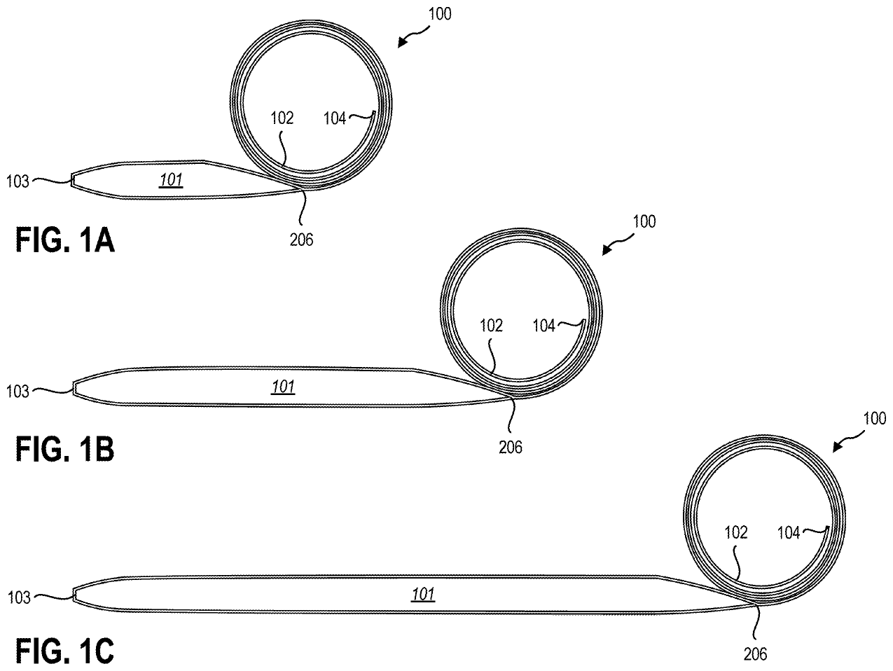

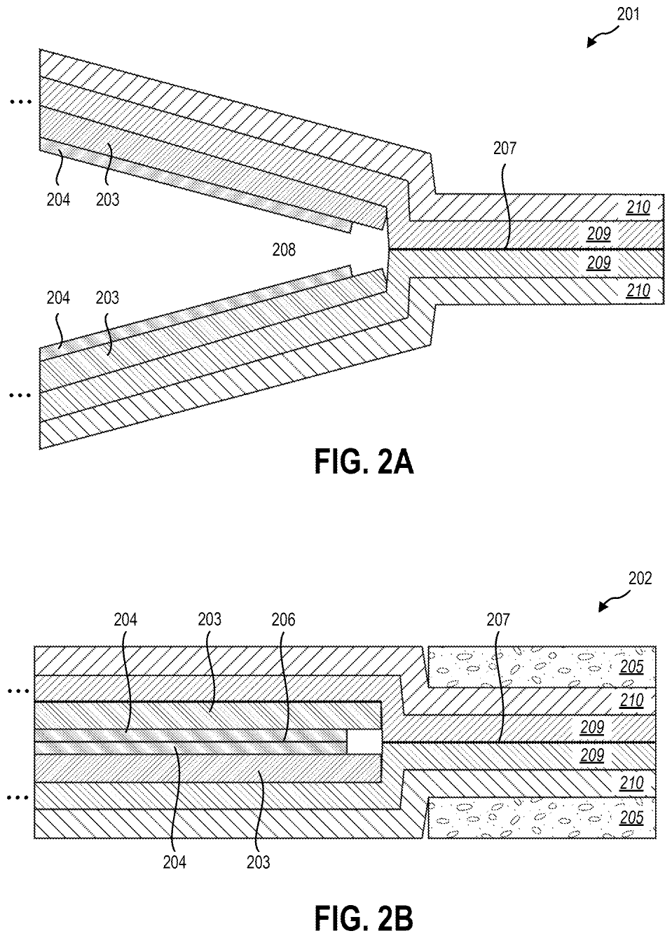

FIG. 1A through 1C depicts a Self-Sensing Extending Actuator 100 with a fluid inlet 103 followed by an expanded section 101 filled with the pressurized fluid (e.g., liquid or gas), a more distal coiled section 102, and terminated in a sealed end 104. The transition between the expanded section 101 and the flat coiled section 102 creates an internal electrical junction 206 between conductive layers (206, FIG. 2). The sequence of FIGS. 1A, 1B, 1C depict the extension of the self-sensing actuator as driven by the pressurized fluid.

FIGS. 2A and 2B depicts an embodiment of layers that can be used to form the self-sensing actuator 100. FIG. 2A depicts an expanded edge cross-section 201 corresponding to the expanded section (101, FIG. 1) of the self-sensing actuator (100, FIG. 1). The pressurized fluid 208 is contained within the actuator volume by the sealed edge 207. The sealed edge 207 is formed by a co-joined adhesive 209 between two layers of adhesive backing 210. The pressurized fluid 208 pushes apart the inner section of the actuator because that area is not adhered. In the depicted embodiment, the inner section is not adhered because the two layers of adhesive 209 are not adhered to each other but rather they each adhered to a mask 203. The masks 203 include a conductive layer 204 that is separated by the pressurized fluid 208 in the expanded section 101. The edges of the conductive layer 204 may not extend as far towards the sealed edge 207 as the mask 203 does. In at least one example, the mask 203 extends closer to the sealed edge 207 than the conductive layer(s). This prevents the formation of an undesirable internal electrical junction (206, FIG. 2B) before the beginning of the coiled section (102, FIG. 1). While a pressurized fluid 208 is described, the pressurized fluid may be a gas in some embodiments.

FIG. 2B depicts an embodiment of layers in a coiled edge cross-section 202, corresponding to the coiled section (102, FIG. 1) of the self-sensing actuator (100, FIG. 1). In the coiled section (102, FIG. 1), the two conductive layers 204 are brought into contact, forming an internal electrical junction 206.

During fabrication, a spacer 205 may be used on the outside of the adhesive backing 210 to force the adhesive 209 together to form a sealed edge 207. This spacer 205 may be discarded after fabrication and not used as part of the self-sensing actuator

One method of fabrication is to use an adhesive 209 that is thermally activated on an adhesive backing 210 that can be thermoformed. The mask 203 can also be thermoformable. In this method of fabrication, the layers, including the spacer 205, are wound around a cylindrical mandrel and heated until the adhesive 209 has bonded and any bending stress in the mask 203 and adhesive backing 210 has relaxed. The coil is then cooled while wound around the cylindrical mandrel.

Alternatively, the layers could be adhered on a flat surface, and then wound around a mandrel and heated or otherwise formed into a coil shape.

In another alternative embodiment, seals between layers would be created with a welding process rather than with adhesive. For example, the sealed edge may be manufactured with thermal welding process (e.g., at least partially melting of the backing material). In some examples, the sealed edge may be manufactured by an ultrasonic welding process.

Winding the layers onto a cylindrical mandrel before adhesion shifts the backing layers slightly in a longitudinal direction relative to one another, before adhesion, due to the different arc-lengths each backing layer must traverse at its individual bending radius. For example, the first backing layer has a smaller bending radius while following a shorter path around the mandrel when positioned radially inside the second backing layer, and the second backing layer has a larger bending radius while following a longer path around the mandrel (and first backing layer) when positioned radially outside the first backing layer. When wound in this way and then adhered, the backing layers are bonded to one another in a coiled configuration. In some embodiments, adhering or otherwise bonding the layers together while coiled prevents wrinkles and other undesirable characteristics. The coiled configuration introduces an elastic strain to the material when in a flat or expanded configuration, causing a restoring force that coils the device upon removal of the pressurized fluid.

An alternative fabrication method for shifting the layers before they are adhered or as they are adhered involves laminating the materials together in a roller system with differing tensions and/or roller speeds so that the output from the laminator is tightly coiled. For example, bonding the first backing layer to the second backing layer when the first backing layer is tensioned differently from the second backing layer produces a resultant differential that coils the device. Other layer combinations, arrangements, and/or materials are possible and contemplated with the disclosed system and method.

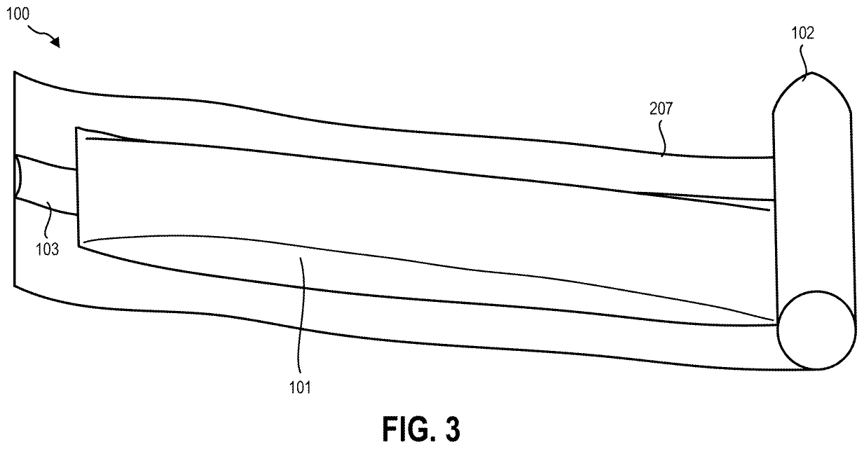

FIG. 3 depicts one embodiment of the self-sensing actuator 100. This embodiment uses a thermally activated adhesive (209, FIG. 2B). The adhesive backing (210, FIG. 2B) and mask (203, FIG. 2B) material may be polyester (polyethylene terephthalate, PET). The mask may be metalized. The adhesive (209, FIG. 2B) and adhesive backing (210, FIG. 2B) may be a standard paper lamination film with a nominal combined thickness of 0.005 inches, resulting in a nominal thickness of 0.01-inches at the sealed edge 207. Each “mylar” mask (203, FIG. 2B) with metalized conductive layer (204, FIG. 2B) may have a nominal combined thickness of 0.002-inches. The mask (203, FIG. 2B) and conductive layer (204, FIG. 2B) may be cut so that they could extend out of the pressurized volume near the fluid inlet 103 on respective sides while being sealed by the adhesive (209, FIG. 2B). This allows an electrical connection to be made to measure the resistance of the circuit without releasing pressurized fluid. The conductive layers near the fluid inlet 103 may also be masked with a thin layer of high-temperature tape to prevent a premature internal electrical junction (206, FIG. 2B) near the fluid inlet 103. The layers may be arranged and wound around a cylindrical aluminum mandrel approximately 2 cm in diameter and heated in an oven at 150 degrees Celsius. The device may then be cooled and removed from the mandrel. The device as depicted is partially expanded with air. Other materials, dimensions, gasses and/or liquids are possible and contemplated with the disclosed system and method.

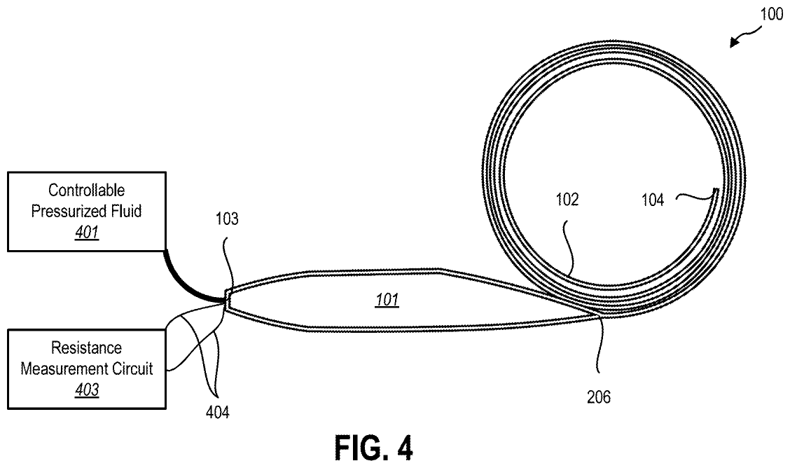

FIG. 4 depicts the self-sensing extending actuator 100 in combination with a fluid controller 401 and a resistance meter 403. The fluid controller 401 adds or removes fluid from the expanded section 101 via a fluid tube 402. As fluid is added, the actuator extends and as fluid is removed, the actuator retracts by re-coiling. As the actuator extends, the distance between the fluid inlet 103 and the internal electrical junction 206 increases. This increase in distance proportionally increases the distance of an electrical circuit formed by the internal electrical junction 206 and the ends of the conductive layers near the fluid inlet 103. Thus, there is an approximately linear relationship between the resistance of the circuit, measured by the resistance measurement circuit 403, and length of the actuator 100. Thus, by connecting electrical wires 404 to the conductive layers (204, FIG. 2B) near the fluid inlet 103, and measuring the resistance of the circuit with a resistance meter 403, the length of the expanded section 101 can be determined. This resistance measurement can be used, for example, as feedback for the fluid controller 401 so that fluid can be controlled such that the actuator achieves a desired length based at least partially on the resistance measurement. The fluid controller 401 and/or the resistance measurement circuit 403 may be a processor having addressable memory in one embodiment.

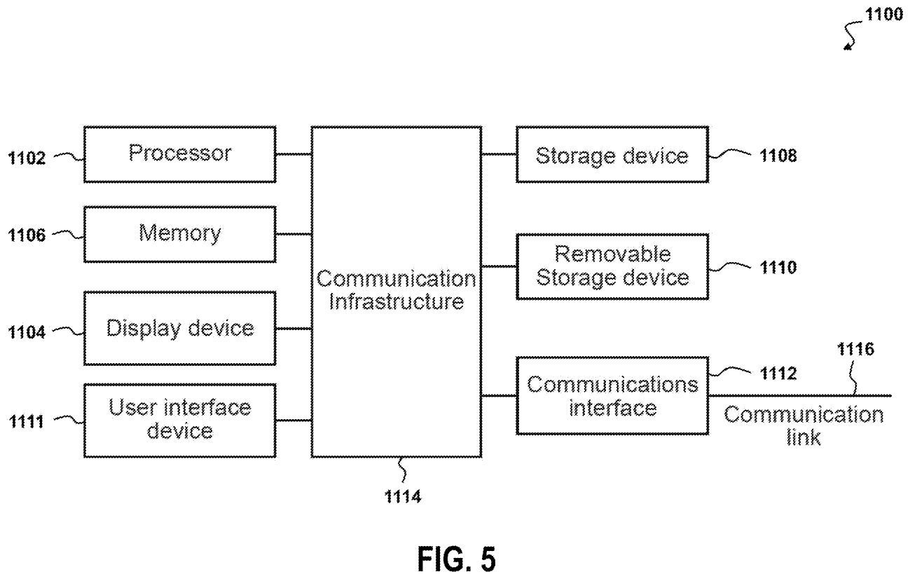

FIG. 5 is a high-level block diagram 1100 showing a computing system comprising a computer system useful for implementing an embodiment of the system and process, disclosed herein. Embodiments of the system may be implemented in different computing environments. The computer system includes one or more processors 1102, and can further include an electronic display device 1104 (e.g., for displaying graphics, text, and other data), a main memory 1106 (e.g., random access memory (RAM)), storage device 1108, a removable storage device 1110 (e.g., removable storage drive, a removable memory module, a magnetic tape drive, an optical disk drive, a computer readable medium having stored therein computer software and/or data), user interface device 1111 (e.g., keyboard, touch screen, keypad, pointing device), and a communication interface 1112 (e.g., modem, a network interface (such as an Ethernet card), a communications port, or a PCMCIA slot and card). The communication interface 1112 allows software and data to be transferred between the computer system and external devices. The system further includes a communications infrastructure 1114 (e.g., a communications bus, cross-over bar, or network) to which the aforementioned devices/modules are connected as shown.

Information transferred via communications interface 1114 may be in the form of signals such as electronic, electromagnetic, optical, or other signals capable of being received by communications interface 1114, via a communication link 1116 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1112. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

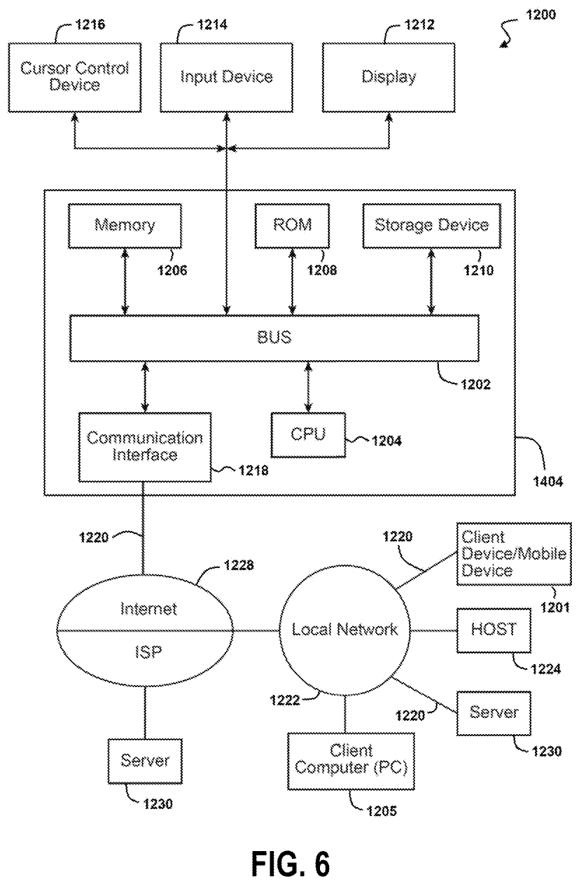

FIG. 6 shows a block diagram of an example system 1200 in which an embodiment may be implemented. The system 1200 includes one or more client devices 1201 such as consumer electronics devices, connected to one or more server computing systems 1230. A server 1230 includes a bus 1202 or other communication mechanism for communicating information, and a processor (CPU) 1204 coupled with the bus 1202 for processing information. The server 1230 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution or instructions to be executed by the processor 1204. The server computer system 1230 further includes a read only memory (ROM) 1208 or other static storage device coupled to the bus 1202 for storing static information and instructions for the processor 1204. A storage device 1210, such as a magnetic disk or optical disk, is provided and coupled to the bus 1202 for storing information and instructions. The bus 1202 may contain, for example, thirty-two address lines for addressing video memory or main memory 1206. The bus 1202 can also include, for example, a 32-bit data bus for transferring data between and among the components, such as the CPU 1204, the main memory 1206, video memory and the storage 1210. Alternatively, multiplex data/address lines may be used instead of separate data and address lines.

The server 1230 may be coupled via the bus 1202 to a display 1212 for displaying information to a computer user. An input device 1214, including alphanumeric and other keys, is coupled to the bus 1202 for communicating information and command selections to the processor 1204. Another type or user input device comprises cursor control 1216, such as a mouse, a trackball, or cursor direction keys for communicating direction information and command selections to the processor 1204 and for controlling cursor movement on the display 1212.

According to one embodiment, the functions are performed by the processor 1204 executing one or more sequences of one or more instructions contained in the main memory 1206. Such instructions may be read into the main memory 1206 from another computer-readable medium, such as the storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1204 for execution. Such a medium may take many forms, including but not limited to, non-volatile media, volatile media, and transmission media. Non-volatile media includes, for example, optical or magnetic disks, such as the storage device 1210. Volatile media includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the server 1230 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received from the main memory 1206 may optionally be stored on the storage device 1210 either before or after execution by the processor 1204.

The server 1230 also includes a communication interface 1218 coupled to the bus 1202. The communication interface 1218 provides a two-way data communication coupling to a network link 1220 that is connected to the world wide packet data communication network now commonly referred to as the Internet 1228. The Internet 1228 uses electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

In another embodiment of the server 1230, interface 1218 is connected to a network 1222 via a communication link 1220. For example, the communication interface 1218 may be an integrated services digital network (ISDN) card or a modem to provide a data communication connection to a corresponding type of telephone line, which can comprise part of the network link 1220. As another example, the communication interface 1218 may be a local area network (LAN) card to provide a data communication connection to a compatible LAN. Wireless links may also be implemented. In any such implementation, the communication interface 1218 sends and receives electrical electromagnetic or optical signals that carry digital data streams representing various types of information.

The network link 1220 typically provides data communication through one or more networks to other data devices. For example, the network link 1220 may provide a connection through the local network 1222 to a host computer 1224 or to data equipment operated by an Internet Service Provider (ISP). The ISP in turn provides data communication services through the Internet 1228. The local network 1222 and the Internet 1228 both use electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

The server 1230 can send/receive messages and data, including e-mail, program code, through the network, the network link 1220 and the communication interface 1218. Further, the communication interface 1218 can comprise a USB/Tuner and the network link 1220 may be an antenna or cable for connecting the server 1230 to a cable provider, satellite provider or other terrestrial transmission system for receiving messages, data and program code from another source.

The example versions of the embodiments described herein may be implemented as logical operations in a distributed processing system such as the system 1200 including the servers 1230. The logical operations of the embodiments may be implemented as a sequence of steps executing in the server 1230, and as interconnected machine modules within the system 1200. The implementation is a matter of choice and can depend on performance of the system 1200 implementing the embodiments. As such, the logical operations constituting said example versions of the embodiments are referred to for e.g., as operations, steps or modules.

Similar to a server 1230 described above, a client device 1201 can include a processor, memory, storage device, display, input device and communication interface (e.g., e-mail interface) for connecting the client device to the Internet 1228, the ISP, or LAN 1222, for communication with the servers 1230.

The system 1200 can further include computers (e.g., personal computers, computing nodes) 1205 operating in the same manner as client devices 1201, wherein a user can utilize one or more computers 1205 to manage data in the server 1230.

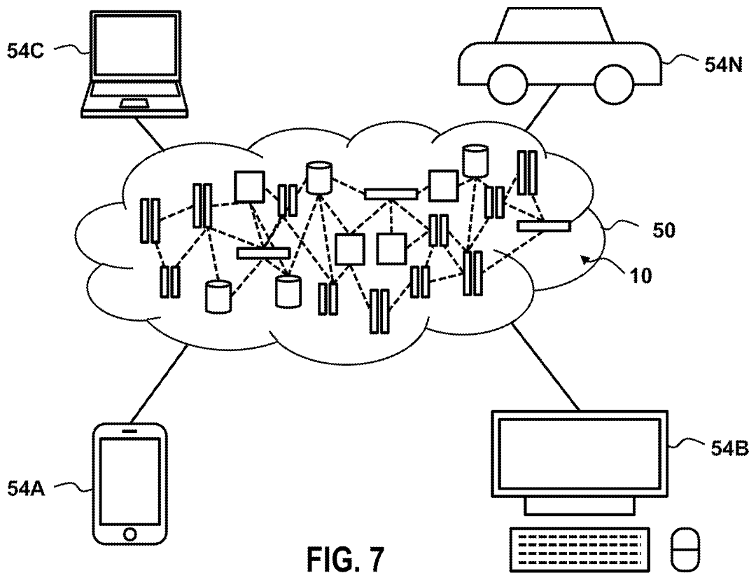

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

The following list includes a number of reference numbers and associated elements that are described herein in connection with one or more embodiments. It will be appreciated that while one or more embodiments elements are described in connection with specific figures, features and functionality described in connection with each of the references/features can apply to other illustrated implementations. Thus, these references are not intended to be limited to the specific illustrated examples shown in the appended figures.
100 Self-Sensing Extending Actuator
101 Expanded Section
102 Coiled Section
103 Fluid Inlet
104 Sealed End
201 Expanded Edge Cross-Section
202 Coiled Edge Cross-Section
203 Mask
204 Conductive Layer
205 Spacer
206 Internal Electrical Junction
207 Scaled Edge
208 Pressurized Fluid
209 Adhesive
210 Adhesive Backing
401 Fluid Controller
402 Fluid Tube
403 Resistance Meter
404 Electrical Wires

What is claimed is:

1. A device comprising a:
a coiled section configured to be expanded into an expanded section via addition of a pressurized fluid through a fluid inlet, wherein the coiled section comprises a sealed end, and wherein the expanded section and the coiled section comprise sealed edges to contain the pressurized fluid; and
one or more conductive layers configured to form an internal electrical junction at a point of transition between the coiled section and expanded section, wherein a length of the expanded section is configured to be determined by measuring a resistance of a circuit formed by the one or more conductive layers.

2. The device of claim 1, wherein the one or more conductive layers includes a first conductive layer and a second conductive layer.

3. The device of claim 2, wherein the first conductive layer and the second conductive layer contact one another in the coiled section and do not contact one another in the expanded section.

4. The device of claim 1, further comprising a mask between a backing of the expanded section and at least one conductive layer of the one or more conductive layers.

5. The device of claim 4, wherein the mask extends closer to the sealed edge than the at least one conductive layer.

6. The device of claim 4, wherein the conductive layer is a metallized layer of the mask.

7. The device of claim 1, wherein the sealed edge includes a co-joined adhesive.

8. The device of claim 7, wherein the co-joined adhesive is a thermally activated adhesive.

9. The device of claim 7, wherein an adhesive backing of the co-joined adhesive is thermoformable.

10. The device of claim 1, wherein the sealed edge includes a weld.

11. The device of claim 1, further comprising a fluid controller connected to the fluid inlet and configured to provide the pressurized fluid to the expanded section.

12. The device of claim 11, wherein the fluid controller is configured to remove fluid from the expanded section.

13. A method comprising:
measuring, by electrical wires, a resistance of a circuit formed by conductive layers; and
controlling, by a fluid controller, a fluid added via a fluid inlet to achieve a desired length of an expanded section based on the measurement of the resistance of the circuit.

14. The method of claim 13, further comprising removing fluid via the fluid inlet based at least partially on the measurement of the resistance.

15. A method of fabrication of a self-sensing fluid-driven actuator:
shifting a first backing layer relative to a second backing layer in a longitudinal direction, wherein the first backing layer is coupled to a first conductive layer and the second backing layer is coupled to a second conductive layer; and
bonding the first backing layer to the second backing layer at a sealed edge in a coiled configuration.

16. The method of claim 15, wherein shifting the first backing layer relative to the second backing layer includes coiling the first backing layer and second backing layer around a mandrel with the second backing layer radially outside the first backing layer.

17. The method of claim 15, wherein shifting the first backing layer relative to the second backing layer includes tensioning the first backing layer differently from the second backing layer.

18. The method of claim 15, wherein bonding the first backing layer to the second backing layer includes adhering the first layer to the second layer.

19. The method of claim 15, wherein bonding the first backing layer to the second backing layer includes welding the first layer to the second layer.

20. The method of claim 19, wherein welding includes ultrasonic welding.
